(19) United States
(12) Patent Application Publication
(10) Pub. No.: US 2018/0075451 A1
(43) Pub. Date: Mar. 15, 2018

(54) Transaction Method and Transaction System

(71) Applicants: Inventec (Pudong) Technology Corp., Shanghai (CN); Inventec Corporation, Taipei (TW)

(72) Inventor: Tsung-Cheng YANG, Taipei City (TW)

(21) Appl. No.: 15/552,296

(22) PCT Filed: Mar. 25, 2016
(86) PCT No.: PCT/CN2016/077347

§ 371 Date: Aug. 21, 2017

(30) Foreign Application Priority Data
Nov. 30, 2015 (CN) 201510856123.X

(51) Int. Cl. G06Q 20/40; G06Q 20/38

(52) U.S. Cl. CPC G06Q 20/4014; G06Q 20/3829; G06Q 20/385

(57) ABSTRACT

A transaction method includes a first electronic device sending a transaction request to a cloud server; the cloud server sending a key information to the first electronic device; the first electronic device performing an identity verification according to the key information and generating a verification result; the cloud server sending a token to the first electronic device when the verification result indicates the identity verification is successful, wherein the token includes an expiry period; and the first electronic device being allowed to perform a transaction within the expiry period.

### BACKGROUND OF THE INVENTION

### 1. Field of the Invention

The present invention relates to a transaction method and a transaction system, and more particularly, to a transaction method and a transaction system capable of enhancing transaction security.

### 2. Description of the Prior Art

As the network technology evolves, online shopping provides people more conveniences. Nevertheless, transaction security is one of the largest concerns of buyers. For example, even though the buyer may choose to pay online by credit card, the buyer may still worry that the seller does not ship the goods after the buyer pays. Furthermore, the buyer may choose cash on delivery or paid by third-party. Nevertheless, the buyer has to prepare the cash in advance if cash on delivery is chosen, which brings inconvenience. In addition, the buyer has to transfer cash in advance if the third-party payment is chosen, which exists a risk of the cash being peculated. In addition, if the buyer chooses to pay-at-pickup from convenience store, there is a risk of the goods which the buyer likes to buy being embezzled. Therefore, it is necessary to improve the prior art.

### SUMMARY OF THE INVENTION

It is therefore a primary objective of the present invention to provide a transaction method and a transaction system capable of enhancing transaction security, to improve over disadvantages of the prior art.

An embodiment of the present invention discloses a transaction method comprising a first electronic device sending a transaction request to a cloud server; the cloud server sending a key information to the first electronic device; the first electronic device performing an identity verification according to the key information and generating a verification result; the cloud server sending a token to the first electronic device when the verification result indicates that the identity verification is successful, wherein the token comprises an expiry period; and the first electronic device being allowed to perform a transaction within the expiry period.

An embodiment of the present invention further discloses transaction system comprising a cloud server comprising a key generating module, configured to generate a key information; and a token generator, configured to generate a token, wherein the token comprises an expiry period; and a first electronic device, comprising a first network connection module configured to establish a first network connection with the cloud server; wherein the first electronic device sends a transaction request to the cloud server, the cloud server sends the key information to the first electronic device, the cloud server sends the token to the first electronic device when a verification result of the first electronic device performing an identity verification according to the key information indicates that the identity verification is successful, and the first electronic device is allowed to perform a transaction within the expiry period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a transaction system according to an embodiment of the present invention.

FIG. 2 is a schematic diagram of a transaction process according to an embodiment of the present invention.

FIG. 3 is a schematic diagram of a transaction system according to an embodiment of the present invention.

FIG. 4 is a schematic diagram of a transaction process according to an embodiment of the present invention.

### DETAILED DESCRIPTION

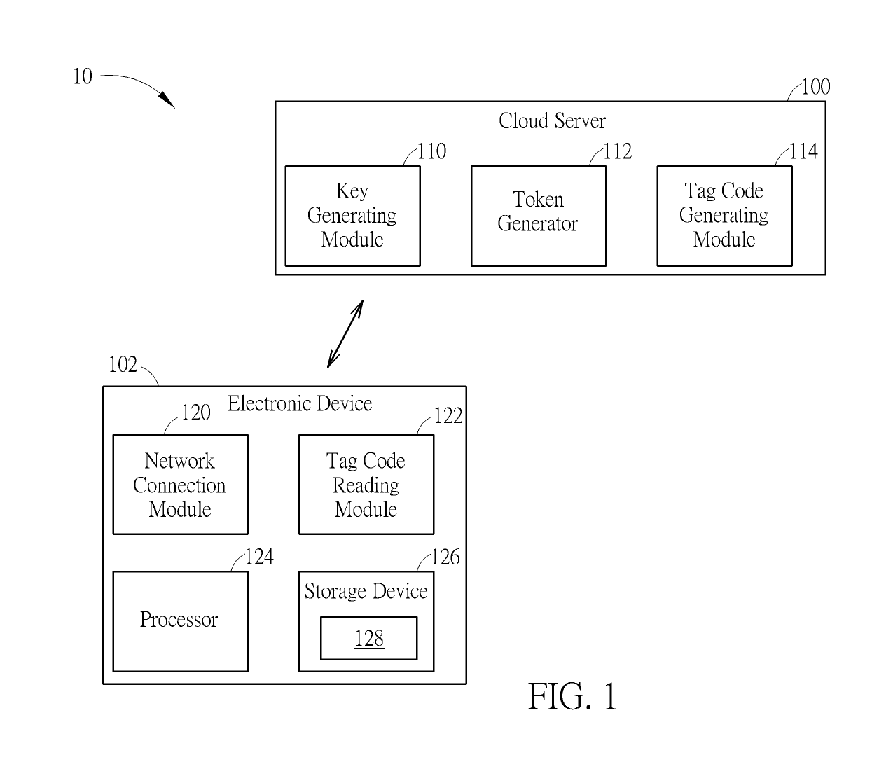

FIG. 1 is a schematic diagram of a transaction system 10 according to an embodiment of the present invention. The transaction system 10 comprises a cloud server 100 and an electronic device 102. The cloud server 100 may be a business level or high level server, which comprises a key generating module 110, a token generator 112 and a tag code generating module 114. The token generator 112 is configured to generate a token TKN. The key generating module 110 is configured to generate a key information KEY. The key information KEY comprises a public key information KEY_PB and a private key information KEY_PV. The tag code generating module 114 is configured to generate a tag code CD. The tag code CD may be a two-dimensional (2D) bar code, a quick response code (QR code), a near field communication tag (NFC Tag), or a bluetooth tag. The cloud server 100 may send the tag code CD, the token TKN and the key information KEY to the electronic device 102 via the Internet or other network.

The electronic device 102 is an electronic device carried by a buyer user BU. The electronic device 102, which may be a smart phone or a tablet, is equipped with a network communication function. The electronic device 102 comprises a network connection module 120, a tag code reading module 122, a processor 124 and a storage device 126. The network connection module 120 is configured to establish a first network connection with the cloud server 100 so as to perform data transmission. For example, the electronic device 102 may receive the key information KEY and the token TKN sent by the cloud server 100 via the network connection module 120. Preferably, the network connection module 120 is a wireless network connection module. In addition, the tag code reading module 122 is configured to read the tag code CD. For example, the tag code reading module 122 may comprise an optical lens and an image recognition module configured to read the 2D bar code or the QR code. In addition, the tag code reading module 122 may be an NFC module or a Bluetooth module configured to read the NFC tag or the Bluetooth tag. The storage device 126 is configured to store the token TKN and the key information KEY sent by the cloud server 100. In addition, the storage device 126 further stores a program code 128, where the program code 128 is configured to instruct the processor 124 to perform operations such as send transaction requests, identity verification or online payments, etc.

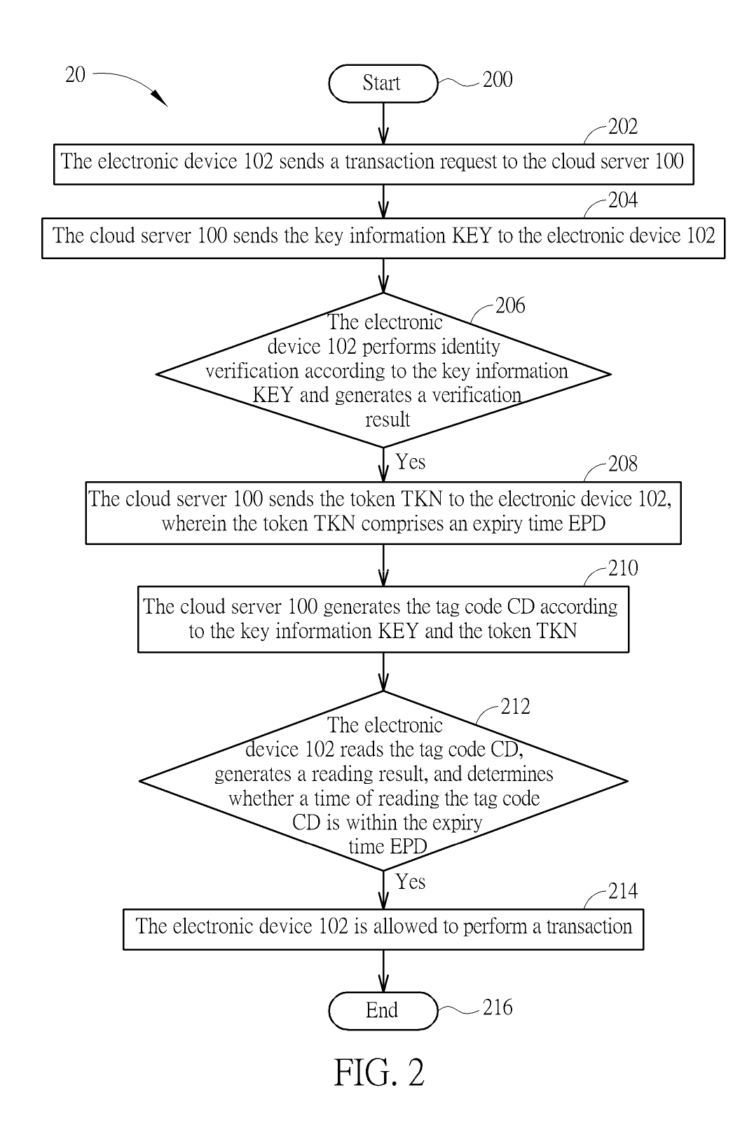

Furthermore, to enhance transaction security, the buyer user BU may shop online by the transaction system 10. Please refer to FIG. 2 to see detailed operations. FIG. 2 is a schematic diagram of a transaction process 20 according to an embodiment of the present invention. The transaction process 20 is executed by the transaction system 10, which comprises the following steps:

Step 200: Start.

Step 202: The electronic device 102 sends a transaction request to the cloud server 100.

Step 204: The cloud server 100 sends the key information KEY to the electronic device 102.

Step 206: The electronic device 102 performs identity verification according to the key information KEY and generates a verification result. If the verification result indicates that the identity verification is successful, go to Step 208.

Step 208: The cloud server 100 sends the token TKN to the electronic device 102, wherein the token TKN comprises an expiry period EPD.

Step 210: The cloud server 100 generates the tag code CD according to the key information KEY and the token TKN.

Step 212: The electronic device 102 reads the tag code CD, generates a reading result, and determines whether a time of reading the tag code CD is within the expiry period EPD. If the reading result is successful and the time of reading the tag code is within the expiry period EPD, go to Step 214.

Step 214: The electronic device 102 is allowed to perform a transaction.

Step 216: End.

The transaction process 20 is able to enhance the transaction security of the buyer user BU shopping on the internet. Detailed operations are described as follows. In Step 202, the buyer user BU sends the transaction request related to a transaction to the cloud server 100 via the electronic device 102. The transaction request may include a product information and a price related to a goods GD which the buyer user BU likes to buy, and a transaction method related to the transaction. The transaction method may be pay-on-delivery (a.k.a, cash on delivery), pay-at-pickup from convenience store, etc. In Step 204, the cloud server 100 sends the key information KEY to the electronic device 102. The key information KEY comprises the public key information KEY_PB and the private key information KEY_PV. After the electronic device 102 receives the key information KEY, the electronic device 102 stores the key information KEY in the storage device 126. In other words, whether the transaction method is pay-on-delivery or pay-at-pickup from convenience store, the courier or the store clerk should perform identity verification via the key information KEY of the electronic device 102. That is, the courier or the store clerk verifies the identity of the buyer user BU by verifying that the electronic device 102 is the electronic device carried by the buyer user BU.

In Step 206, the electronic device 102 performs the identity verification according to the key information KEY. The processor 124 of the electronic device 102 may access the key information KEY stored in the storage device 126 for the buyer user to perform the identity verification, or the program code 128 may instruct the processor 124 to perform a decryption process according to the public key information KEY_PB and the private key information KEY_PV. The decryption process using the public key information KEY_PB and the private key information KEY_PV is known by one who skilled in the art, which is not narrated herein for brevity.

When the identity verification is successful, in Step 208, the cloud server 100 send the token TKN to the electronic device 102, where the token TKN includes the expiry period EPD. After the electronic device 102 receives the token TKN, the electronic device 102 stores the token TKN in the storage device 126. In addition, in Step 210, the cloud server 100 generate the tag code CD according to the key information KEY and the token TKN. A seller may stick the tag code CD on the goods GD which the buyer user BU likes to buy. Hence, the tag code CD would be delivered along with the goods GD through a logistics company to an address or a convenience store specified by the buyer user BU. Notably, the tag code CD is generated according to the key information KEY, and the tag code CD is successfully read only by electronic devices having the key information KEY.

After the goods GD are delivered to the address or the convenience store specified by the buyer user BU and before the courier or the store clerk hands the goods GD to the buyer user BU, in Step 212, the buyer user BU should use the electronic device 102 to read the tag code CD stuck on the goods GD. The electronic device 102 would generate the reading result and determine whether the time of the electronic device 102 reading the tag code CD is within the expiry period EPD. The reading result being fail represents that the goods taken out by the courier/the store clerk are not the goods GD specified by the buyer user BU. The reading result being fail may also represent that the electronic device reading the tag code CD is not the electronic device 102, which represents the person who attempted to get the goods GD from the courier/the store clerk is not the buyer user BU himself/herself. Therefore, the right goods GD are guaranteed to be handed to the right buyer user BU, and the transaction security concerned with by both sides (buyer side and seller side) is secured. In addition, the electronic device 102 needs to determine whether the time of the tag code CD being read is within the expiry period EPD, so as to avoid the goods GD to be misappropriated by one who finds the electronic device 102 lost by the buyer user BU.

When the electronic device 102 successfully reads the tag code CD and the time of the electronic device 102 reading the tag code CD is within the expiry period EPD, in Step 214, the electronic device 102 is allowed to perform the transaction. In other words, when the electronic device 102 successful reads the tag code CD and the time of the electronic device 102 reading the tag code CD is within the expiry period EPD, the buyer user BU is allowed to perform an online payment via the electronic device 102. The online payment is not limited. For example, the buyer user BU may pay by credit card online via the electronic device 102. Alternatively, the buyer user BU may send a cash-transfer confirmation message to the cloud server 100, and the cloud server 100 then sends the cash-transfer confirmation message to bank(s) specified by both sides, such that cash-transfer is accomplished.

As can be seen from the above, the present invention utilizes the key information KEY and the token TKN to generate the tag code CD, and utilizes whether the electronic device 102 is able to successfully read the tag code CD and the time of the electronic device 102 reading the tag code CD is within the expiry period EPD as evidence to verifying the goods GD and the buyer user BU. Compared to the prior art, the present invention is able to guarantee that the right goods are handed to the right buyer, so as to enhance the transaction security.

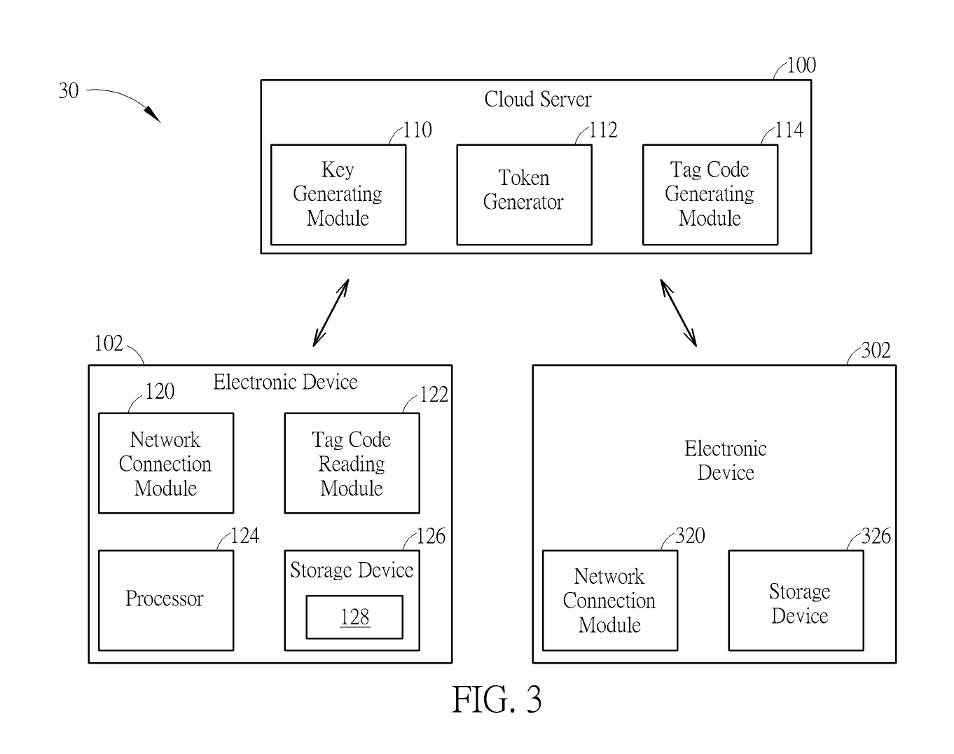

Notably, the embodiments stated in the above are utilized for illustrating the concept of the present invention. Those skilled in the art may make modifications and alternations accordingly, and not limited herein. For example, the embodiments stated in the above take pay-on-delivery or pay-at-pickup from convenience store as example to illustrate the concept of the present invention, but not limited herein. The present invention may be applied to transaction being made face to face/in person. Specifically, please refer to FIG. 3, which is a schematic diagram of a transaction system 30 according to an embodiment of the present invention. The transaction system 30 is similar to the transaction system 10, and thus, the same components are denoted by the same symbols. Different from the transaction system 10, the transaction system 30 further comprises an electronic device 302. The electronic device 302 is an electronic device carried by a seller user SU. The electronic device 302, which may be a smart phone or a tablet as well, is also equipped with a network communication function. The electronic device 302 comprises a network connection module 320 and a storage device 326. The network connection module 320 is configured to receive the key information KEY and the token TKN sent by the cloud server 100. After the electronic device 302 receives the key information KEY and the token TKN, the electronic device 302 stores the key information KEY and the token TKN in the storage device 326. When the buyer user BU and the seller user SU meet with each other, the buyer user BU and the seller user SU may use the key information KEY stored in the electronic device 102 and the electronic device 302 to perform identity verification. After the identity verification is successful, the cloud server 100 sends the token TKN to the electronic devices 102, 302. After the electronic devices 102, 302 receive the token TKN, and the transaction is carried out, which means that, at this time, the seller user SU may hand the goods GD which the buyer user BU likes to buy to the buyer user BU, and the buyer user BU may pay online via the electronic device 102.

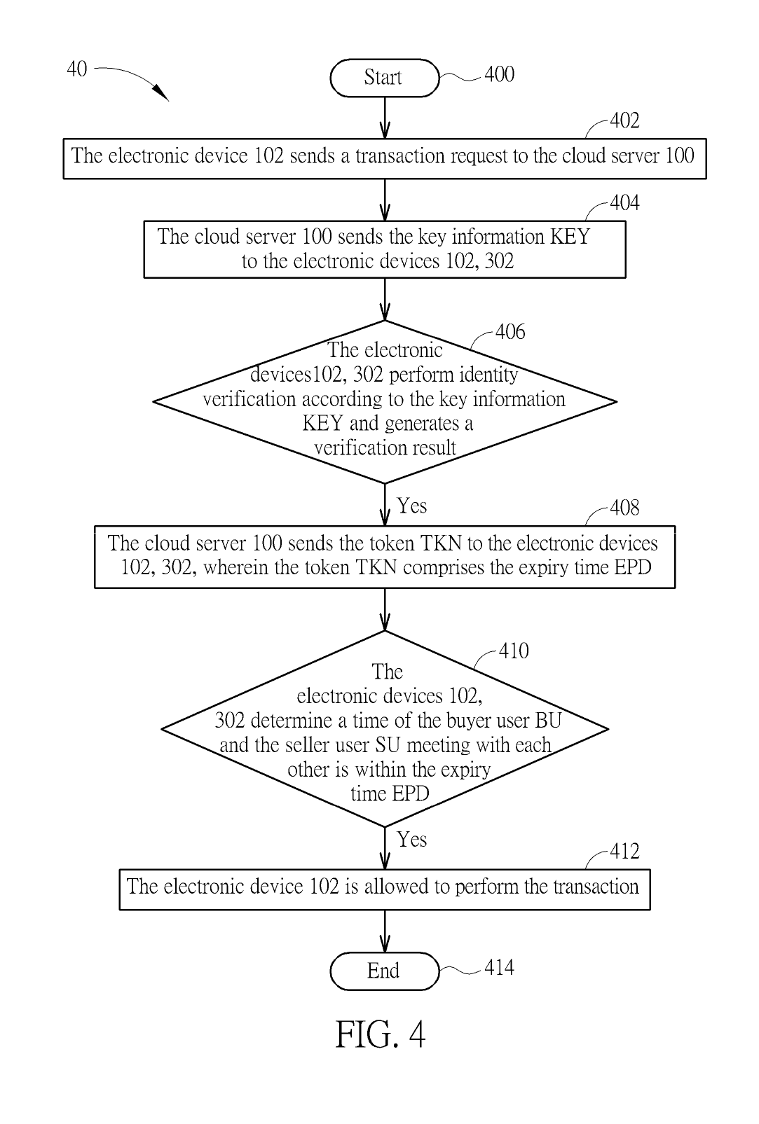

Operations of the transaction system 30 stated in the above may be summarized into a transaction process 40. Please refer to FIG. 4, which is a schematic diagram of the transaction process 40 according to an embodiment of the present invention. The transaction process 40 is executed by the transaction system 30, which comprises the following steps:

Step 400: Start.

Step 402: The electronic device 102 sends a transaction request to the cloud server 100.

Step 404: The cloud server 100 sends the key information KEY to the electronic devices 102, 302.

Step 406: The electronic devices 102, 302 perform identity verification according to the key information KEY and generates a verification result. If the verification result indicates that the identity verification is successful, go to Step 408.

Step 408: The cloud server 100 sends the token TKN to the electronic devices 102, 302, wherein the token TKN comprises the expiry period EPD.

Step 410: The electronic devices 102, 302 determine a time of the buyer user BU and the seller user SU meeting with each other is within the expiry period EPD. If yes, go to Step 412.

Step 412: The electronic device 102 is allowed to perform the transaction.

Step 414: End.

The transaction process 40 is similar to the transaction process 20. Different from the transaction process 20, in Step 404, the cloud server 100 sends the key information KEY, the token TKN to the electronic device 102 and also the electronic device 302. In Step 406, the both sides may perform the identity verification according to the key information KEY. Meanwhile, in Step 410, the electronic devices 102, 302 determine the time of the buyer user BU and the seller user SU meeting with each other is within the expiry period EPD, so as to verify the validity of the identity of the both sides and enhance the transaction security. Detailed operations may be referred to the paragraphs stated in the above, which are not narrated herein for brevity.

In summary, the present invention utilizes the key information and the token to verifying the goods and the identities. Compared to the prior art, the present invention is able to guaranteed that the right goods is handed to the right buyer, so as to enhance the transaction security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transaction method, characterized by comprising:
a first electronic device sending a transaction request to a cloud server;
the cloud server sending a key information to the first electronic device;
the first electronic device performing an identity verification according to the key information and generating a verification result;
the cloud server sending a token to the first electronic device when the verification result indicates that the identity verification is successful, wherein the token comprises an expiry period; and
the first electronic device being allowed to perform a transaction during the expiry period.

2. The transaction method of claim 1, characterized in that the key information comprises a public key information and a private key information.

3. The transaction method of claim 1, characterized by further comprising:
the cloud server generating a tag code according to the key information or the token.

4. The transaction method of claim 3, characterized by further comprising:
the first electronic device reading the tag code according to the key information or the token; and
the first electronic device being allowed to perform the transaction when the first electronic device succeeds in reading the tag code during the expiry period.

5. The transaction method of claim 1, characterized in that the step of the first electronic device being allowed to perform the transaction comprises the first electronic device being allowed to perform an online payment.

6. The transaction method of claim 1, characterized by further comprising:
the cloud server sending the key information to the first electronic device and a second electronic device;
the first electronic device and the second electronic device performing the identity verification according to the key information and generating the verification result; and
the cloud server sending the token to the first electronic device and the second electronic device when the verification result indicates that the identity verification is successful.

7. A transaction system, characterized by comprising:
a cloud server, comprising:
a key generating module, configured to generate a key information; and
a token generator, configured to generate a token, wherein the token comprises an expiry period; and
a first electronic device, comprising a first network connection module configured to establish a first network connection with the cloud server;
wherein the first electronic device sends a transaction request to the cloud server, the cloud server sends the key information to the first electronic device, the cloud server sends the token to the first electronic device when a verification result of the first electronic device performing an identity verification according to the key information indicates that the identity verification is successful, and the first electronic device is allowed to perform a transaction during the expiry period.

8. The transaction system of claim 7, characterized in that the key information comprises a public key information and a private key information.

9. The transaction system of claim 7, characterized in that the cloud server further comprises a tag code generating module, configured to generate a tag code according to the key information or the token.

10. The transaction system of claim 9, characterized in that the first electronic device further comprises:
a tag code reading module, configured to read the tag code according to the key information or the token;
wherein the first electronic device is allowed to perform the transaction when the first electronic device succeeds in reading the tag code during the expiry period.

11. The transaction system of claim 7, characterized in that the first electronic device being allowed to perform the transaction comprises the first electronic device being allowed to perform an online payment.

12. The transaction system of claim 7, characterized by further comprising:
a second electronic device, comprising a second network connection module configured to establish a second network connection with the cloud server;
wherein the cloud server sends the key information to the first electronic device and the second electronic device, the first electronic device and the second electronic device performs the identity verification according to the key information and generates the verification result, and the cloud server sends the token to the first electronic device and the second electronic device when the verification result indicates that the identity verification is successful.
